(19) United States
(12) Patent Application Publication
(10) Pub. No.: US 2015/0188613 A1
(43) Pub. Date: Jul. 2, 2015

(54) APPARATUS FOR PROCESSING INTERMITTENT MESSAGE IN TRAIN SYSTEM

(71) Applicant: LSIS CO., LTD., Anyang-si (KR)

(72) Inventor: Jae Mun HAN, Incheon (KR)

(73) Assignee: LSIS CO., LTD., Anyang-si (KR)

(21) Appl. No.: 14/570,871

(22) Filed: Dec. 15, 2014

(30) Foreign Application Priority Data
Dec. 26, 2013 (KR) 10-2013-0163484

(51) Int. Cl. H04B 7/01; H04L 27/22

(52) U.S. Cl. CPC H04B 7/01; H04L 27/22

(57) ABSTRACT

Disclosed is an apparatus for processing an intermittent message in a train system. The apparatus includes an antenna, a filter unit and a signal processing unit. The antenna receives an intermittent message signal transmitted through an intermittent loop installed on a rail line. The filter unit performs band pass filtering on the intermittent message signal, and separates the intermittent message signal into first data having a first frequency and second data having a second frequency. The signal processing unit generates data corresponding to an intermittent message by synchronizing the phase of the second data with that of the first data.

### CROSS-REFERENCE TO RELATED APPLICATIONS

Pursuant to 35 U.S.C. §119(a), this application claims the benefit of earlier filing date and right of priority to Korean Application No. 10-2013-0163484, filed on Dec. 26, 2013, the contents of which is incorporated by reference herein in its entirety.

### BACKGROUND OF THE DISCLOSURE

1. Field of the Disclosure

The present disclosure relates to an apparatus for processing an intermittent message in a train system.

2. Description of the Background Art

In general, a train control signal system uses a continuous message continuously transmitted through a rail line of a railroad, and an intermittent message transmitted through an intermittent loop installed on the rail line in order to transmit an intermittent message.

The continuous message is a message continuously required during traveling of a train, such as a speed code or an inclination of the rail line, and the discontinuous message is a message on a specific area of the rail line, such as a tunnel position, an insulation section or a bridge position.

In conventional processing of an intermittent message, if a signal converted into a phase shifted key (PSK) is transmitted through an intermittent message transmission loop installed on the ground, a PSK signal is received through an antenna for intermittent message reception, installed in a train, and the received analog signal is converted into a digital signal through a band pass filter. Then, meaningful data are extracted from the converted signal, and the extracted data are transmitted to a controller, thereby performing train control. However, a change in phase, generated when the analog signal passes through the filter, should be corrected, and hence a conventional art has been proposed as follows in order to solve a problem in that a phase correction error may occur.

[Document 1] Korean Patent Publication No. 2008-0029589, published on Apr. 3, 2008.

However, according to Document 1, phase difference correction is performed once, and there is a problem in that the accuracy and success rate in signal processing of intermittent messages are low. That is, intermittent message signals transmitted from a plurality of intermittent loops existing in a traveling section of the train are not uniform due to their analog characteristics, and therefore, phase differences between the intermittent message signals are various. As a result, there is a problem in that the processing of these signals is inaccurately performed.

### SUMMARY OF THE DISCLOSURE

Therefore, an aspect of the detailed description is to provide an apparatus for processing an intermittent message in a train system, in which signals received through an intermittent antenna are signal-processed in parallel through a plurality of phase adjusting modules, thereby increasing the accuracy in data processing.

To achieve these and other advantages and in accordance with the purpose of this specification, as embodied and broadly described herein, an apparatus for processing an intermittent message, the apparatus includes: an antenna configured to receive an intermittent message signal transmitted through an intermittent loop installed on a rail line; a filter unit configured to perform band pass filtering on the intermittent message signal, and separate the intermittent message signal into first data having a first frequency and second data having a second frequency; and a signal processing unit configured to generate data corresponding to an intermittent message by synchronizing the phase of the second data with that of the first data.

In one exemplary embodiment, the signal processing unit may include a plurality of phase shift units configured to receive in parallel the second data and shift different phases; a decoder unit configured to output a binary signal using the first data, and second data of which phase is synchronized with that of the first data among the plurality of second data of which different phases are shifted by the plurality of phase shift units; and a data processing unit configured to output the binary signal received from the decoder unit as data of a predetermined frame.

In one exemplary embodiment, the data processing unit may include a data generation unit configured to convert the binary signal received from the decoder into a binary bit signal having a pattern; a data conversion unit configured to the binary bit signal having the pattern, which is received from the data generation unit, into predetermined data bits; and a frame generation unit configured to gather the data bits from the data conversion unit as many as a predetermined number of bits, and convert the gathered data bits into a data frame of a message transmitted from the intermittent loop.

In one exemplary embodiment, the apparatus may further include a first edge detection unit configured to detect an edge of the second data received from the filter unit and change the waveform of the second data into a square wave.

In one exemplary embodiment, the apparatus may further include a second edge detection unit configured to detect an edge of the second data of which phase is shifted by any one of the plurality of phase shift units; and a sampling signal generation unit configured to a sampling signal having a third frequency, in synchronization with an edge detection signal of the second edge detection unit.

In one exemplary embodiment, the decoder unit may output a binary signal in response to the sampling signal from the sampling signal generation unit.

To achieve these and other advantages and in accordance with the purpose of this specification, as embodied and broadly described herein, an apparatus for processing data, which receives first data having a first frequency and second data having a second frequency and decodes the received first and second data, the apparatus includes: a plurality of phase shift units configured to shift different phases with respect to the second data; and a decoder unit configured to output a binary signal using the first data, and second data of which phase is synchronized with that of the first data among the plurality of second data of which different phases are shifted by the plurality of phase shift units.

As described above, according to the present invention, different phases are shifted through the plurality of phase shift units, and decoding is performed using data of which phase is synchronized with that of the first data having the first frequency among the plurality of second data having the second frequency, of which different phases are shifted, so that it is possible to effectively deal with various phase differences between the first and second data.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is an exemplary view illustrating a train system to which the present disclosure is applied;

FIG. 2 is an exemplary view illustrating generation of an intermittent message signal;

FIG. 3 is an exemplary view illustrating a process in which signal processing is performed by an apparatus for processing an intermittent message according to the present disclosure;

FIG. 4 is a configuration view of an apparatus for processing an intermittent message according to an embodiment of the present invention;

FIG. 5 is a detailed configuration view illustrating an embodiment of a signal processing unit of FIG. 4; and

FIG. 6 is an exemplary view illustrating operations of phase shift units and a decoder unit according to the present disclosure.

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

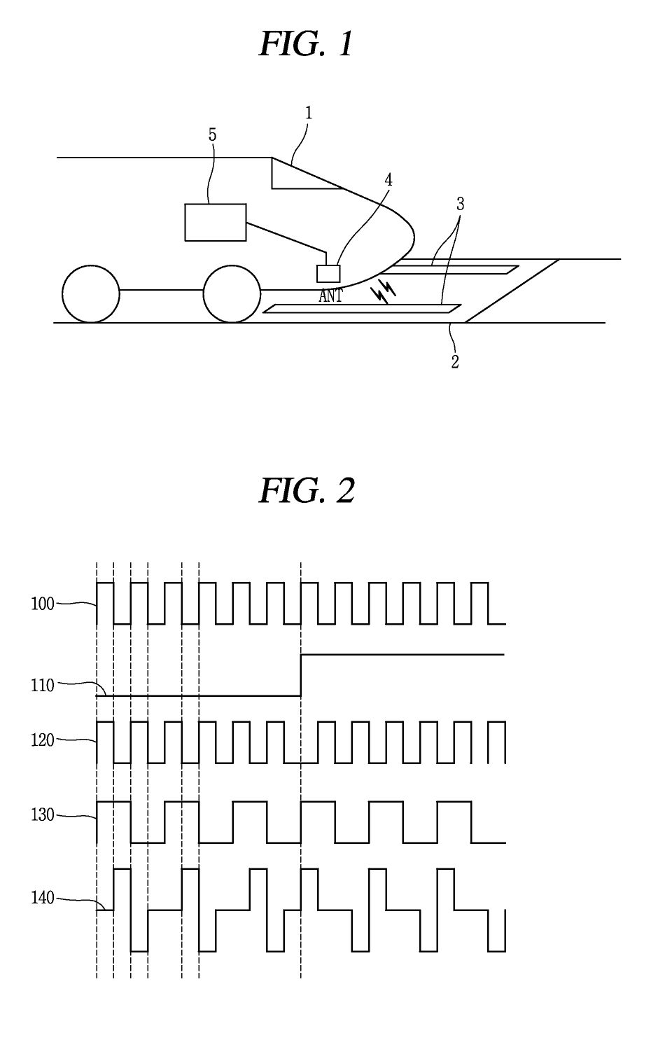

FIG. 1 is an exemplary view illustrating a train system to which the present disclosure is applied, and the train system is briefly shown in FIG. 1.

An intermittent loop 3 for previously transmitting, to a train 1, an intermittent message of a specific area as a radio signal is installed at a predetermined distance ahead of a specific area on a rail line 2, e.g., a tunnel, an insulation section in which a message signal cannot be received, or a bridge.

The train 1 is provided with an intermittent antenna 4 for receiving intermittent message signals and an on-board equipment 5 for performing signal processing by receiving signals from the antenna 4. The present disclosure is provided to the on-board equipment 5.

A process of generating an intermittent message signal from the intermittent loop 3 will be described with reference to FIG. 2. FIG. 2 is an exemplary view illustrating generation of an intermittent message signal.

100 is the waveform of a first carrier signal having a first frequency (e.g., 125 KHz), and 110 is the waveform of a message signal having intermittent information. 130 is the waveform of a second carrier signal having a second frequency (e.g., 62.6 KHz).

First, a primary modulation signal shown in 120 is generated by performing an exclusive AND operation on the first carrier signal of 100 and the message signal of 110. Then, a secondary modulation signal is generated by subtracting the modulation signal of 120 from the second carrier signal of 130.

Thus, the signal finally transmitted from the intermittent loop 3 is a signal with a waveform shown in 140.

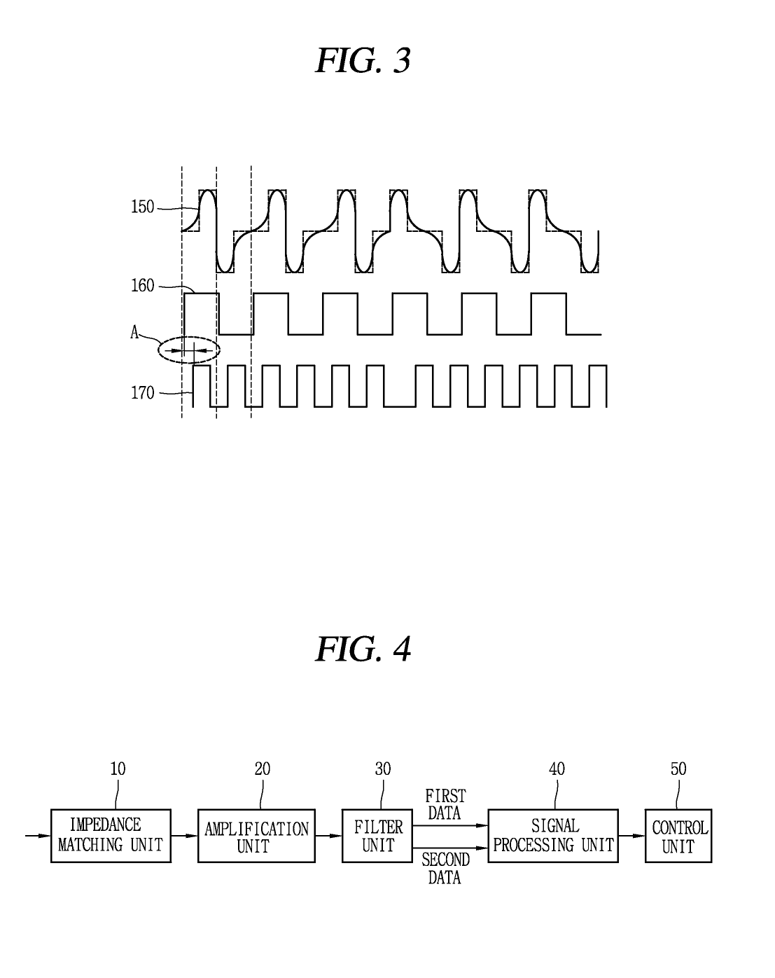

FIG. 3 is an exemplary view illustrating a process in which signal processing is performed by an apparatus for processing an intermittent message according to the present disclosure.

The signal received by the antenna 4 of FIG. 1 is an analog signal as shown in 150 of FIG. 3. The apparatus of the present disclosure may receive an analog signal, and separate the received signal into signals of 160 and 170 to be output. It can be seen that 160 and 170 of FIG. 3 are signals corresponding to 130 and 120 of FIG. 2, respectively. Meanwhile, a phase difference between the signals having the first and second frequencies of 160 and 170 may occur in a process of converting an analog signal into digital data and processing the converted data. Referring to A of FIG. 3, it can be seen that a phase difference occurs.

FIG. 4 is a configuration view of an apparatus for processing an intermittent message according to an embodiment of the present invention. The apparatus is provided to the on-board equipment of FIG. 1, and a signal as shown in 150 of FIG. 3 may be received from the intermittent antenna 4.

As shown in FIG. 4, the apparatus according to the embodiment of the present disclosure may include an impedance matching unit 10, an amplification unit 20, a filter unit 30, a signal processing unit 40 and a control unit 50.

The impedance matching unit 10 is connected to the intermittent antenna 4 in order to prevent reflection of an intermittent message signal received through the intermittent antenna 4. The amplification unit 20 amplifies an analog signal received through the impedance matching unit 10, and performs band pass filtering on the received analog signal, so that, as shown in 160 and 170 of FIG. 3, the analog signal can be separated into first data having a first frequency and second data having a second frequency, which are digital data.

In this state, a phase difference as shown in A of FIG. 3 occurs between the two data due to characteristics of the filter unit 30. The phase difference acts as an important defect in decision of 1 and 0 of data. Meanwhile, a plurality of intermittent loops 3 as shown in FIG. 1 are disposed on the rail line 2. A plurality of intermittent message signals from the plurality of intermittent loops are not all uniform due to analog characteristics, and therefore, phase differences between the intermittent message signals are various. The signal processing unit 40 can precisely perform signal processing on intermittent message signals having various phase differences.

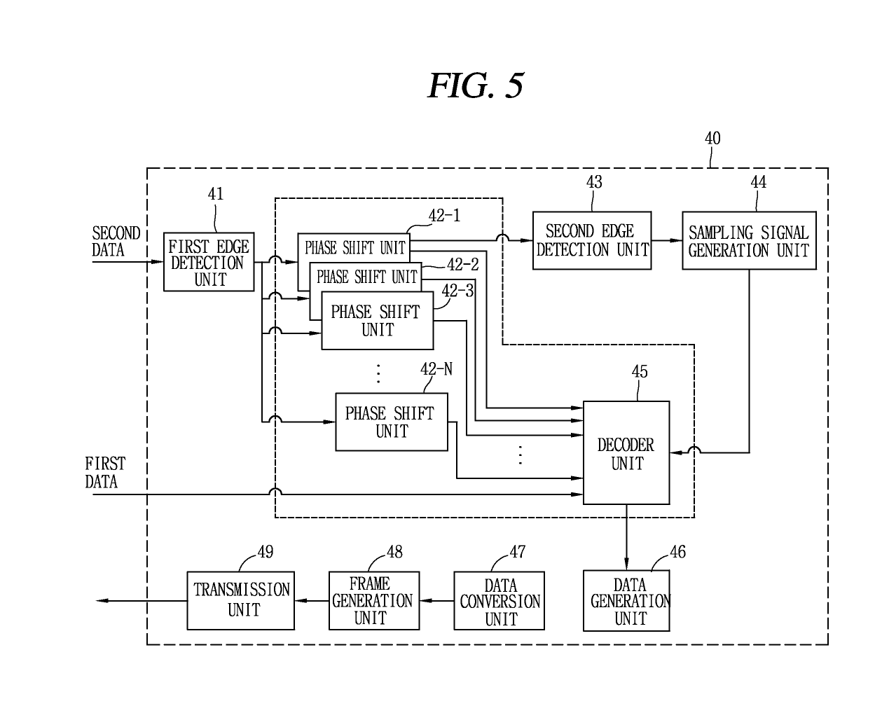

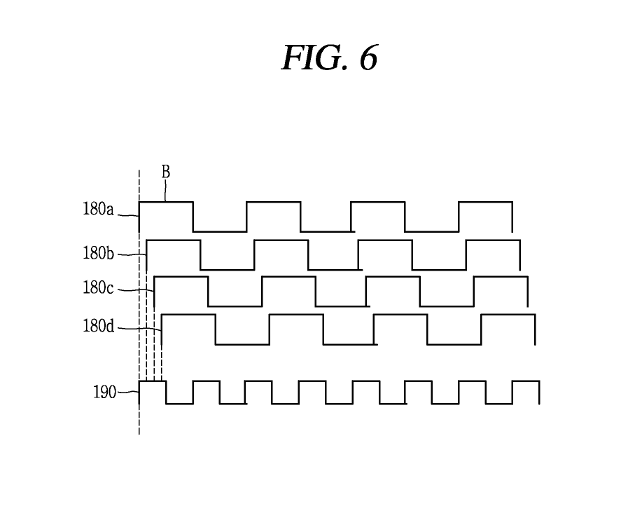

FIG. 5 is a detailed configuration view illustrating an embodiment of the signal processing unit of FIG. 4.

As shown in FIG. 5, the signal processing unit 40 according to the embodiment of the present invention may include a first edge detection unit 41, a plurality of phase shift units 42, a second edge detection unit 43, a sampling signal generation unit 44, a decoder unit 45, a data generation unit 46, a data conversion unit 47, a frame generation unit 48 and a transmission unit 49.

The first edge detection unit 41 may detect an edge of the second data having the second frequency (e.g., 62.5 KHz), and change the waveform of the second data into a square wave to be output.

The output of the first edge detection unit 41 is divided into a plurality of outputs (N outputs), so that the plurality of outputs are input in parallel to the plurality of phase shift units 42, respectively. In order to recover a phase difference of the second data with respect to the first data, the plurality of phase shift units 42 may perform phase shift on data input with different phases. That is, various phase differences occur in a process of converting different intermittent message signals into digital data through the filter unit 30. In the signal processing unit 40 according to the embodiment of the present invention, in order to solve a problem in that there occurs a case where data are not recovered even by the phase shift of one phase shift unit 42, the plurality of phase shift units 42 connected in parallel may shift different phases with respect to the second data, and provide the shifted phases to the decoder unit 45.

The second edge detection unit 43 may receive an output of any one phase shift unit 42-1 among the plurality of phase shift units 42, and detect an edge of the second data having the second frequency, output from the phase shift unit 42-1 in order to provide a periodic signal for sampling. The sampling signal generation unit 44 may generate a sampling signal having a third frequency (e.g., 250 KHz) in synchronization with an edge detection signal provided by the second edge detection unit 43.

The decoder unit 45 receives first data having the first frequency from the filter unit 30, and receives a plurality of second data of which different phases are shifted from the plurality of phase shift units 42, so that a binary signal is output using the first data and second data of which phase is synchronized with that of the first data, in response to the sampling signal of the sampling signal generation unit 44.

That is, the plurality of phase shift units 42 may output a plurality of second data having different phase differences, and the decoder unit 45 may output a binary signal using any one second data of which phase is synchronized with that of the first data among the plurality of second data having different phases.

The data generation unit 46 converts the binary signal received from the decoder unit 45 into a binary bit signal having a pattern, and outputs the converted binary bit signal. That is, for example, 50 binary signals are grouped by the unit of four bits, to convert the binary signals into binary signals having a pattern such as 1010 or 0010.

The data conversion unit 47 receives data from the data generation unit 46, and converts the received data into data bits according to a predetermined communication protocol, based on the binary bit signal having the pattern. That is, a communication protocol is previously set in which, for example, the patterns 1010 and 0010 are determined as 0 and 1, respectively. In this state, if a binary bit signal having the pattern 1010 is input from the data generation unit 46, the pattern 1010 may be converted into 0. If a binary bit signal having the pattern 0010 is input from the data generation unit 46, the pattern 0010 may be converted into 1. Here, that a binary signal having a predetermined pattern of data bits is again converted into a signal of 0 or 1 refers to conversion of data bits into a valid data bit.

The frame generation unit 48 may gather data bits from the data conversion unit 47 as many as a predetermined number of bits, to convert the gathered data bits into a data frame of a message transmitted from the intermittent loop 3 on the ground. In this state, the predetermined number of bits gathered by the frame generation unit 48 is, for example, 55 bits.

The transmission unit 49 transmits, to the control unit 50, the data frame received from the frame generation unit 48 as an intermittent message. The transmission unit 49 may transmit the data frame using RS-232C or RS-485 or using a serial communication scheme such as a controller area network (CAN).

The controller 50 may receive a data frame through serial communication from the transmission unit 49, so that the intermittent message from the intermittent loop on the ground can be used in control of the train 1.

As described above, according to the present disclosure, an intermittent message received from the intermittent loop 3 on the ground, the received intermittent message is converted into a digital signal, and the converted digital signal is again transmitted as a serial signal to the controller 50.

FIG. 6 is an exemplary view illustrating operations of phase shift units and the decoder unit according to the present disclosure.

As shown in FIG. 6, the plurality of phase shift units 42 may shift, in parallel, different phases of the input second data having the second frequency, to be output as shown in 180a to 180d, and the decoder unit 45 may perform decoding, using second data (waveform B in 180a) of which phase is synchronized with that of the first data of 190 among the plurality of second data of which different phases are shifted.

In the conventional art having one phase shift unit, if the phase of the second data is not synchronized with that of the first data even by phase shift, the decoder unit 45 cannot output any data. However, according to the present disclosure, second data of which phase is synchronized with that of the first data among the plurality of second data can be used, thereby improving the reliability in data processing.

As described above, according to the present disclosure, different phases are shifted through the plurality of phase shift units 42, and decoding is performed using data of which phase is synchronized with that of the first data having the first frequency among the plurality of second data having the second frequency, of which different phases are shifted, so that it is possible to easily deal with a phase difference generated by the filter unit 30. Further, it is possible to effectively deal with various phase differences generated in various intermittent messages transmitted from the plurality of intermittent loops 3 on the rail line 2.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An apparatus for processing an intermittent message, the apparatus comprising:
an antenna configured to receive an intermittent message signal transmitted through an intermittent loop installed on a rail line;
a filter unit configured to perform band pass filtering on the intermittent message signal, and separate the intermittent message signal into first data having a first frequency and second data having a second frequency; and
a signal processing unit configured to generate data corresponding to an intermittent message by synchronizing the phase of the second data with that of the first data.

2. The apparatus of claim 1, wherein the signal processing unit includes:
a plurality of phase shift units configured to receive in parallel the second data and shift different phases;
a decoder unit configured to output a binary signal using the first data, and second data of which phase is synchronized with that of the first data among the plurality of second data of which different phases are shifted by the plurality of phase shift units; and
a data processing unit configured to output the binary signal received from the decoder unit as data of a predetermined frame.

3. The apparatus of claim 2, wherein the data processing unit includes:
a data generation unit configured to convert the binary signal received from the decoder into a binary bit signal having a pattern;
a data conversion unit configured to the binary bit signal having the pattern, which is received from the data generation unit, into predetermined data bits; and
a frame generation unit configured to gather the data bits from the data conversion unit as many as a predetermined number of bits, and convert the gathered data bits into a data frame of a message transmitted from the intermittent loop.

4. The apparatus of claim 2, further comprising a first edge detection unit configured to detect an edge of the second data received from the filter unit and change the waveform of the second data into a square wave.

5. The apparatus of claim 2, further comprising:
a second edge detection unit configured to detect an edge of the second data of which phase is shifted by any one of the plurality of phase shift units; and
a sampling signal generation unit configured to a sampling signal having a third frequency, in synchronization with an edge detection signal of the second edge detection unit.

6. The apparatus of claim 5, wherein the decoder unit outputs a binary signal in response to the sampling signal from the sampling signal generation unit.

7. An apparatus for processing data, which receives first data having a first frequency and second data having a second frequency and decodes the received first and second data, the apparatus comprising:
a plurality of phase shift units configured to shift different phases with respect to the second data; and
a decoder unit configured to output a binary signal using the first data, and second data of which phase is synchronized with that of the first data among the plurality of second data of which different phases are shifted by the plurality of phase shift units.
